(19) United States
(12) Patent Application Publication
(10) Pub. No.: US 2015/0309627 A1
(43) Pub. Date: Oct. 29, 2015

(54) TOUCH PANEL AND TOUCH DISPLAY PANEL

(71) Applicants: HEFEI BOE OPTOELECTRONICS TECHNOLOGY CO., LTD., Hefei, Anhui (CN); BOE TECHNOLOGY GROUP CO., LTD., Beijing (CN)

(72) Inventors: YUBO XU, Beijing (CN); XIAOFANG GU, Beijing (CN); JIUZHAN ZHANG, Beijing (CN); MING CHEON HU, Beijing (CN); BYUNG CHEON LIM, Beijing (CN)

(21) Appl. No.: 14/348,755

(22) PCT Filed: Apr. 24, 2013
(86) PCT No.: PCT/CN2013/074628

§ 371 Date: Mar. 31, 2014

(30) Foreign Application Priority Data
Feb. 28, 2013 (CN) 201310064106.3

(51) Int. Cl. G06F 3/047; G09G 5/00; G06F 3/044; G06F 3/045; G09G 3/36

(52) U.S. Cl. CPC G06F 3/047; G06F 3/045; G09G 3/3611; G06F 3/044; G09G 5/003; G09G 2300/0426

(57) ABSTRACT

The present invention discloses a touch panel and a touch display panel, and the touch panel comprises driving lines and sensing lines crossing with each other, and in the extending direction of the driving lines, two line ends of each row/column of the driving lines having the largest distance therebetween are connected with a drive signal input line, and each row/column of the sensing lines is connected with a signal gathering line; and/or, in the extending direction of the sensing lines, two line ends of each row/column of the sensing lines having the largest distance therebetween are connected with a signal gathering line. The present invention achieves the following advantageous effects: through driving the touch panel bilaterally, or dividing the panel into a plurality of touch units, each touch unit is individually driven, which is equivalent to dividing a large-sized touch panel into small-sized touch panels; then the delay of the drive signal of the large-sized panel is improved, and the touch sensitivity is enhanced and the yield of the touch panel is also improved.

### TECHNICAL FIELD

Embodiments of the present invention relates to a touch panel and a touch display panel.

### BACKGROUND

Currently, in the field of liquid crystal display, integrating a touch structure within a display structure has been a main trend, and we usually call it an in-cell touch panel. Such a structure design has following advantages: 1. the overall display panel becomes thinner and lighter, and then consumers' demand on super-thin display is met; and 2. the traditional fabricating process of a touch panel is omitted, thus production cost is lowered and product competence is enhanced.

However, current in-cell touch panel technologies still have following problems: a panel display function and a touch function affect each other, which results in the problem of display noise; restricted by a too large RC load, it is difficult to achieve a large-sized panel of in-cell touch, and overall yield is not high. The reason is that, for a large-sized panel, due to the increase of the parasitic capacitance of resistance, a drive signal is delayed sharply and error is generated, and then a sensing signal as received also shades sharply, which seriously affects the receipt of the touch signal and touch sensitivity.

### SUMMARY

The present invention aims to provide a touch panel and a touch display panel, so as to solve the problems in the prior art that the yield of produced large-sized touch display panels is low due to the increase of the drive resistance and the parasitic capacitance in the large-sized touch display panels, and that touch sensitivity is low due to the sharp delay of the drive signal.

The objects of the present invention are achieved through the following technical solutions.

The embodiment of the present invention provide a touch panel comprising driving lines and sensing lines crossing with each other, and in the extending direction of the driving lines, two line ends of each row/column of the driving lines having the largest distance therebetween are connected with a drive signal input line; and/or, in the extending direction of the sensing line, two line ends of each column/row of the sensing lines having the largest distance therebetween are connected with a signal gathering line.

Preferably, the touch panel further comprises a plurality of pixels formed by the surrounding of gate lines and data lines, and each of the pixels comprises a corresponding common electrode; each row/column of the driving lines at least comprises the common electrodes of the pixels in a first pixel group constituted by the pixels in an extending direction, and a first conductor which electrically connects the common electrodes of the pixels in the first pixel group; and each column/row of the sensing lines at least comprises the common electrodes of the pixels in a second pixel group forming a part of the sensing lines, and a second conductor which is in the extending direction of the sensing lines and electrically connects the common electrodes of the pixels in the second pixel group contained by each of the sensing lines.

Preferably, each row/column of the driving lines is as an integral drive line; or, each row/column of the driving lines comprises two driving lines independent of each other.

Preferably, each column/row of the sensing lines is as an integral sensing line; or, each column/row of the sensing lines comprises two sensing lines independent of each other.

Preferably, the touch panel further comprises ground conductors provided in the extending direction of the sensing lines and between the pixels of the first pixel group and the pixels of the adjacent second pixel group.

Preferably, the ground conductors are electrically connected with each other through a ground line.

Preferably, among the pixels contained by the first pixel group, the common electrodes of adjacent pixels are connected with each other to form an integral one.

Preferably, among the pixels contained by the second pixel group, the common electrodes of adjacent pixels are connected with each other to form an integral one.

Preferably, the first conductor is a transparent conductive film ITO conductor, and the second conductor is an ITO conductor or a metal bridge line.

The touch display panel provided by the embodiments of the present invention comprises the above touch panel.

The embodiments of the present invention achieve the following advantageous effects: the two line ends of each row/column of the driving lines of the touch panel having the largest distance therebetween are connected with the drive signal input line and receive the drive signal. That is, when each row/column of driving lines is as an integral drive line, the two ends receive the drive signal; or, when each row/column of the driving lines comprises two independent driving lines, the end of the two independent driving lines close to the outer side of the panel receives the drive signal, and this is equivalent to divide the overall panel into at least two small panels to drive. Thus, the delay of the drive signal of the large-sized panel is improved, and the touch sensitivity is enhanced and the yield of the touch panel is also improved.

### BRIEF DESCRIPTION OF THE DRAWINGS

In order to more clearly illustrate the technical solutions of the embodiments of the invention, the drawings of the embodiments will be briefly described in the following; it is obvious that the described drawings are only related to some embodiments of the invention and thus are not limitative of the invention.

FIG. 1 is a schematic diagram of the touch panel provided by one embodiment of the present invention;

FIG. 2 is a schematic diagram of the driving lines in a touch unit provided by one embodiment of the present invention;

FIG. 3 is a schematic diagram of the sensing lines in the touch unit provided by one embodiment of the present invention;

FIG. 4 is a schematic diagram of the structure of the touch panel provided by another embodiment of the present invention;

FIG. 5 is a schematic diagram of the structure of another touch panel provided by another embodiment of the present invention;

FIG. 6 is a schematic diagram of the electric field line when the touch panel shown in FIG. 5 is not subjected to a touch action in another embodiment of the present invention; and

FIG. 7 is a schematic diagram of the electric field line when the touch panel shown in FIG. 5 is subjected to a touch action in another embodiment of the present invention.

### DETAILED DESCRIPTION

In order to make objects, technical details and advantages of the embodiments of the invention more apparent, the technical solutions of the embodiments will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise defined, the technical terms or scientific terms used herein should be the general meanings understood by one having ordinary skills in the field of the present invention. The terms “first”, “second” and similar terms used in the description and claims of the present application for a patent for invention do not represent any order, amount or importance, while are just used to differentiate different constituting parts. Likewise, the terms “one”, “a” and similar terms do not represent limitation on amount while refer to at least one. Similar terms such as “including” or “comprising” refer to that an element or article preceding the terms “including” or “comprising” covers the elements, articles and equivalents thereof listed after the terms “including” or “comprising”, and do not exclude other elements or articles. Similar terms such as “connect” or “couple” are not limited to physical or mechanical connections, and can comprise electrical connection, no matter direct or indirect. Terms such as “upper”, “lower”, “left” and “right” are only intended to represent relative position relationships, when the absolute position of a described object is changed, the relative position relationships may be changed correspondingly.

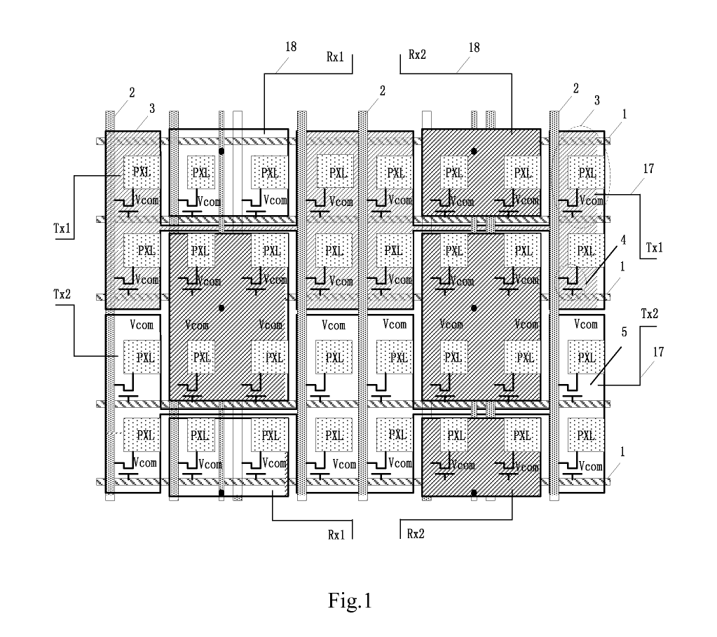

The embodiment of the present invention provides a touch panel, as shown in FIGS. 1-3, the touch panel comprises driving lines (Tx) 11 and sensing lines (Rx) 14 crossing with each other, and each of the driving lines 11 at least comprises the common electrodes 5 (Vcom shown in FIG. 1) of the pixels 3 in the first pixel group 12 forming a part of the driving lines 11, and the first conductor 13 which electrically connects the common electrodes 5 of the pixels 3 in the first pixel group 12 contained by each of the driving lines 11 in the extending direction of the driving lines 11; and each of the sensing lines 14 at least comprises the common electrodes of the pixels 3 in the second pixel group 15 forming a part of the sensing lines 14, and the second conductor 16 which electrically connects the common electrodes 5 of the pixels 3 in the second pixel group 15 contained by each of the sensing lines 14 in the extending direction of the sensing lines 14.

The touch panel further comprises the drive signal input line 17 connected with at least one end of the driving lines 11, and the signal gathering line 18 connected with at least one end of the sensing lines 14.

The first pixel group 12 and the second pixel group 15 are both constituted by the pixels 3 which comprise the circuit elements 4 and the common electrodes 5 shown in FIG. 1.

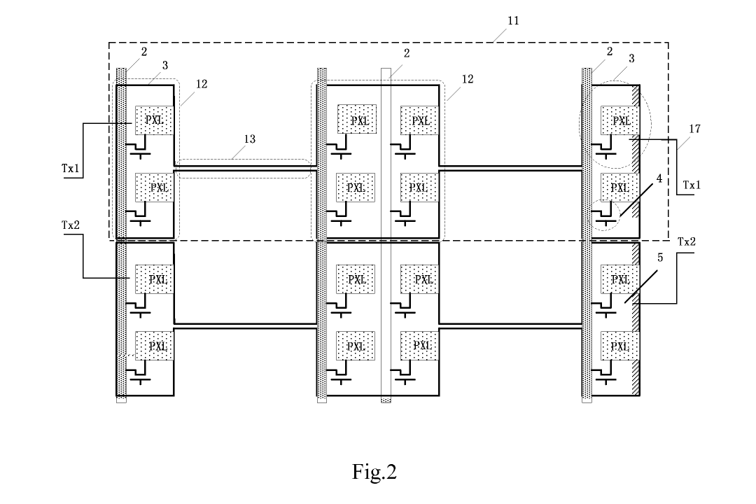

FIG. 2 is a partial schematic diagram of the driving lines 11, and shows the first pixel group 12 and the first conductor 13 constituting each of the driving lines 11, and the first pixel group 12 is constituted by several pixels 3, and the pixels 3 comprise the circuit elements 4 and the common electrodes 5. Wherein, the drive signal input line 17 is connected to two ends of the driving lines 11, that is, to the common electrodes of part of the pixels 3 at two ends of the first pixel group 12, and the other end of the drive signal input line 17 is connected to a drive signal providing unit (not shown in the drawing).

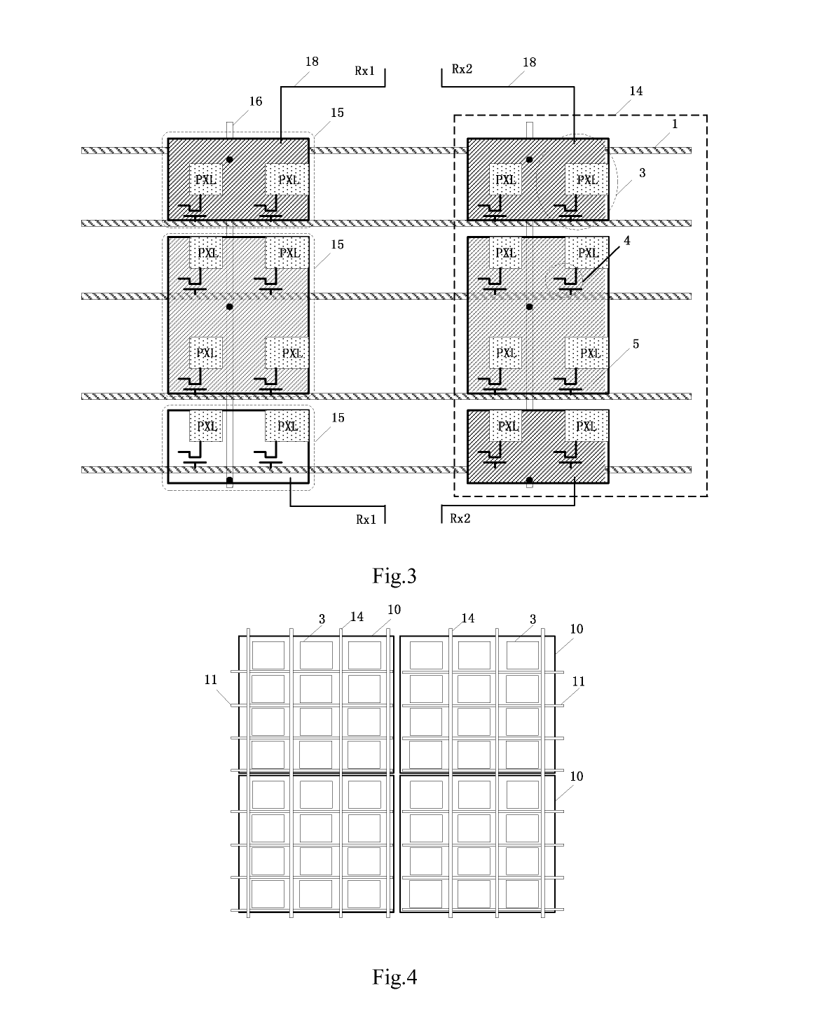

FIG. 3 is a partial schematic diagram of the sensing lines 14, and shows the second pixel group 15 and the second conductor 16 constituting each of the sensing lines 14, and the second pixel group 15 is constituted by several pixels 3, and the pixels 3 comprise the circuit elements 4 and the common electrodes 5. Wherein, the signal gathering line 18 is connected to two ends of the sensing lines 14, that is, to the common electrodes of part of the pixels 3 at two ends of the second pixel group 15, and the other end of the signal gathering line 18 is connected to a signal gathering unit (not shown in the drawing).

It needs to be indicated that, in this embodiment, the entirety of each row/column of driving lines 11 is taken as an example, in this situation, the two line ends of each row/column of the driving lines 11 having the largest distance therebetween in the extending direction are the two ends of the driving lines 11. At this moment, for the drive signal input line 17 and the signal gathering line 18, the drive signal input line 17 is connected to the two ends of the driving lines 11, and the signal gathering line 18 is connected to one end of the sensing lines 14; or, the drive signal input line 17 is connected to the two ends of the driving lines 11, and the signal gathering line 18 is connected to two ends of the sensing line 14.

Of course, besides the above situations, according to the idea of the present invention, when each column/row of the sensing lines 14 is an integral one, the two line ends of each column/row of the sensing lines 14 having the largest distance therebetween in the extending direction are the two ends of the sensing lines 14. At this moment, the drive signal input line 17 and the signal gathering line 18 may further have the following situation: the drive signal input line 17 is connected to one end of the driving lines 11, and the signal gathering line 18 is connected to two ends of the sensing lines 14.

The connection manners of the drive signal input line 17 and the signal gathering line 18 may be subject to choice according to actual design needs, so as to reduce the drive signal delay and enhance touch sensitivity.

Preferably, among the pixels 3 contained by the first pixel group 12, the common electrodes 5 of adjacent pixels 3 are connected with each other to form an integral one; among the pixels contained by the second pixel group 15, the common electrodes of adjacent pixels are connected with each other to form an integral one.

The embodiments of the present invention achieve following advantageous effects: through using a bilateral driving to each touch unit, the drive signal delay of the large-sized panel due to the increase of resistance and parasitic capacitance is improved, thus the yield and touch sensitivity are enhanced.

Preferably, the first conductor is a transparent conductive film ITO (indium tin oxide) conductor, and the second conductor is an ITO conductor or a metal bridge line.

The second embodiment of the present invention provides a touch panel, as shown in FIG. 4, it is a schematic diagram that each row of the driving lines comprises two independent driving lines 11. For each row of the driving lines, it comprises two independent driving lines 11, and the two line ends having the largest distance therebetween in the extending direction of each row of the driving lines are respective one ends of two driving lines 11, and the end of each drive line 11 will be connected with the drive signal input line. For convenient description, the area passed by the driving lines 11 is defined as the touch units 10, that is, as shown in FIG. 4, the touch panel comprises four touch units 10 corresponding to several pixels 3, and the touch units 10 are all driven independently and constitute a touch panel.

The situation that each column of the driving lines comprises two independent driving lines 11 is similar to the above description (at this moment, the sensing lines 14 are arranged in row). That is, for each column of the driving lines, it comprises two independent driving lines 11, the two line ends having the largest distance therebetween in the extending direction of each column of the driving lines are respective one ends of two driving lines 11, and the end of each drive line 11 will be connected with the drive signal input line, which is not repeated herein.

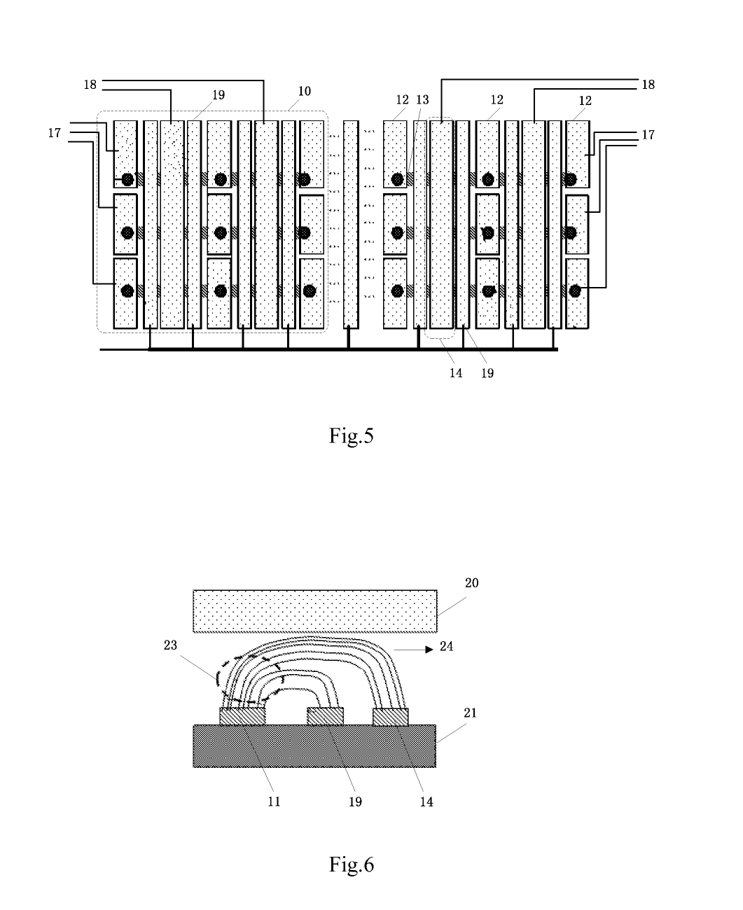

In combination with the parts contained by the touch units in the first embodiment and the touch panel shown in FIG. 4 of this embodiment, this embodiment provides another touch panel, as shown in FIG. 5. The touch panel further comprises several ground conductors 19 which are provided between the pixels 3 of the first pixel group 12 and the pixels 3 of the adjacent second pixel group 15 in the extending direction of the sensing lines 14. The touch panel as shown in FIG. 5 comprises two independent touch units 10, and each row of the driving lines of the touch panel comprises two independent driving lines 11 (the driving lines 11 are not shown in FIG. 5, please refer to FIG. 2) which comprise the first pixel group 12 and the first conductor 13; and the touch panel further comprises the sensing lines 14 (for convenient description, the second pixel group 15 and the second conductor 16 contained by the sensing lines are not shown in FIG. 5, please refer to FIG. 3).

The ground conductors 19 are provided between the first pixel group 12 and the sensing lines 14 (as described in the embodiment, the sensing lines 14 comprise the common electrodes 5 of the pixels 3 in the second pixel group 15) of the driving lines 11, and all the ground conductors 19 contained by the touch panel are connected together through a ground line provided at one side (for example, a lower side) of the panel.

The independent driving lines 11 contained by each row of the driving lines are both unilaterally driven, that is, the end of the driving lines 11 close to outer side of the panel is connected with the drive signal input line 17, and one end (for example, an upper end) of the sensing lines 14 is connected with the signal gathering line 18. An inevitable result is that, when the driving lines are provided in the column direction, the independent driving lines 11 contained by each column of the driving lines are unilaterally driven, that is, the end of the driving lines 11 close to the outer side of the panel is connected with the drive signal input line 17, and one end (for example, the left end) of the sensing lines 14 (at this moment, the sensing lines 14 provided in the row direction) is connected with the signal gathering line 18. Being different from the first embodiment, in this embodiment, although two ends of the touch panel are both connected with the drive signal input line 17, the drive signal input lines 17 at the two ends are not connected and are separated in the middle of the panel, which can decrease the mutual interference between the signal input at the two ends.

It needs to be indicated that this embodiment mainly aims to describe the touch panel and the touch units 10 after the ground conductors 19 are added, thus the specific constitution of the touch units 10 are not described, and the other constituting parts of the touch units 10 in this embodiment are based on the description in the first embodiment, except the ground conductors 19.

According to the touch panel shown by this embodiment, FIG. 6 shows the electric field line between the driving lines 11, the ground conductors 19 and the sensing lines 14 before a finger touches the touch panel. The driving lines 11, the ground conductors 19 and the sensing lines 14 are arranged between the upper substrate 20 and the lower substrate 21. When the touch panel works, the electric field line 23 emitted by the driving lines 11 is in the direction of the electric field direction 24 and terminates at the ground conductors 19 and the sensing lines 14.

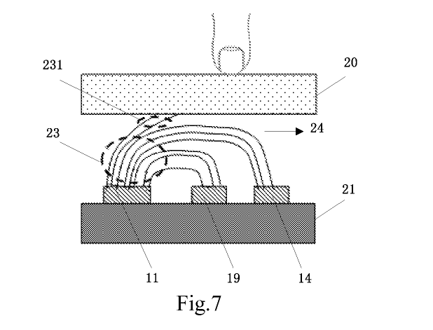

FIG. 7 shows the electric field line between the driving lines 11, the ground conductors 19 and the sensing lines 14 after a finger touches the touch panel. The driving lines 11, the ground conductors 19 and the sensing lines 14 are arranged between the upper substrate 20 and the lower substrate 21, when the touch panel works, the electric field line 23 emitted by the driving lines 11 is in the direction of the electric field direction 24 and partly terminates at the ground conductors 19 and the sensing lines 14, and a part of the electric field line 231 terminates at the upper substrate 20.

In addition, it needs to be indicated that, according to the present invention, the plurality of touch units can input the same frequency of drive signals at the same time, and can also input the same frequency or different frequencies of drive signals according to a certain time sequence, which is omitted herein.

The embodiments of the present invention achieve following advantageous effects: through dividing the panel into a plurality of touch units, each touch unit is individually driven, which is equivalent to dividing a large-sized touch panel into small-sized touch panels, then the drive signal delay of the large-sized panel due to the increase of resistance and parasitic capacitance is improved, thus the yield and touch sensitivity are enhanced.

Obviously one skilled in the art may make vairous modifications and variations to the present invention without departing from the spritis and scope of the present invention. For example, although description is made taking the in-cell touch panel as an example, the present inventionc can also be used in an add-on or out-cell touch panel and then achieve high yield and high touch sensitivity of the large-sized touch panel. Thus, if such variations and modifications to the present invention fall within the scope of the claims of the present invention and equivalent technologies thereof, the present invention shall also contain such modifications and variations.

1. A touch panel, comprising driving lines and sensing lines crossing with each other, and in the extending direction of the driving lines, two line ends of each row/column of the driving lines having the largest distance therebetween are connected with a drive signal input line; and/or, in the extending direction of the sensing lines, two line ends of each column/row of the sensing lines having the largest distance therebetween are connected with a signal gathering line.

2. The touch panel according to claim 1, wherein, the touch panel further comprises a plurality of pixels formed by the surrounding of gate lines and data lines, and each of the pixels comprises a corresponding common electrode; each row/column of the driving lines at least comprises common electrodes of the pixels in a first pixel group constituted by the pixels in an extending direction, and a first conductor which electrically connects the common electrodes of the pixels in the first pixel group; and
each column/row of the sensing lines at least comprises the common electrodes of the pixels in a second pixel group forming a part of the sensing lines, and a second conductor which is in the extending direction of the sensing lines and electrically connects the common electrodes of the pixels in the second pixel group contained by each of the sensing lines.

3. The touch panel according to claim 1, wherein, each row/column of the driving lines is as an integral drive line; or, each row/column of the driving lines comprises two driving lines independent of each other.

4. The touch panel according to claim 1, wherein, each column/row of the sensing lines is as an integral sensing line; or, each column/row of the sensing lines comprises two sensing lines independent of each other.

5. The touch panel according to claim 2, wherein, the touch panel further comprises ground conductors provided in the extending direction of the sensing lines and between the pixels of the first pixel group and the pixels of the adjacent second pixel group.

6. The touch panel according to claim 5, wherein, the ground conductors are electrically connected with each other through a ground line.

7. The touch panel according to claim 2, wherein, among the pixels contained by the first pixel group, the common electrodes of adjacent pixels are connected with each other to form an integral one.

8. The touch panel according to claim 2, wherein, among the pixels contained by the second pixel group, the common electrodes of adjacent pixels are connected with each other to form an integral one.

9. The touch panel according to claim 2, wherein, the first conductor is a transparent conductive film ITO conductor, and the second conductor is an ITO conductor or a metal bridge line.

10. A touch display panel, comprising the touch panel according to claim 1.

11. The touch panel according to claim 2, wherein, each row/column of the driving lines is as an integral drive line; or, each row/column of the driving lines comprises two driving lines independent of each other.

12. The touch panel according to claim 2, wherein, each column/row of the sensing lines is as an integral sensing line; or, each column/row of the sensing lines comprises two sensing lines independent of each other.

13. The touch panel according to claim 10, wherein, the touch panel further comprises a plurality of pixels formed by the surrounding of gate lines and data lines, and each of the pixels comprises a corresponding common electrode; each row/column of the driving lines at least comprises common electrodes of the pixels in a first pixel group constituted by the pixels in an extending direction, and a first conductor which electrically connects the common electrodes of the pixels in the first pixel group; and
each column/row of the sensing lines at least comprises the common electrodes of the pixels in a second pixel group forming a part of the sensing lines, and a second conductor which is in the extending direction of the sensing lines and electrically connects the common electrodes of the pixels in the second pixel group contained by each of the sensing lines.

14. The touch panel according to claim 10, wherein, each row/column of the driving lines is as an integral drive line; or, each row/column of the driving lines comprises two driving lines independent of each other.

15. The touch panel according to claim 13, wherein, each row/column of the driving lines is as an integral drive line; or, each row/column of the driving lines comprises two driving lines independent of each other.

16. The touch panel according to claim 10, wherein, each column/row of the sensing lines is as an integral sensing line; or, each column/row of the sensing lines comprises two sensing lines independent of each other.

17. The touch panel according to claim 13, wherein, each column/row of the sensing lines is as an integral sensing line; or, each column/row of the sensing lines comprises two sensing lines independent of each other.

18. The touch panel according to claim 13, wherein, the touch panel further comprises ground conductors provided in the extending direction of the sensing lines and between the pixels of the first pixel group and the pixels of the adjacent second pixel group.

19. The touch panel according to claim 18, wherein, the ground conductors are electrically connected with each other through a ground line.
